(19) United States
(12) Patent Application Publication
(10) Pub. No.: US 2025/0147385 A1
(43) Pub. Date: May 8, 2025

(54) CAMERA MODULE

(71) Applicant: SAMSUNG ELECTRO-MECHANICS CO., LTD., Suwon-si (KR)

(72) Inventors: Young Hwan KWON, Suwon-si (KR); Do Seop HWANG, Suwon-si (KR); Bo Sung SEO, Suwon-si (KR); Young Bok YOON, Suwon-si (KR); Byung Woo KANG, Suwon-si (KR)

(73) Assignee: SAMSUNG ELECTRO-MECHANICS CO., LTD., Suwon-si (KR)

(21) Appl. No.: 18/894,640

(22) Filed: Sep. 24, 2024

(30) Foreign Application Priority Data
Nov. 3, 2023 (KR) 10-2023-0151212
Mar. 15, 2024 (KR) 10-2024-0036643

(51) Int. Cl. G03B 5/00; G02B 7/09; G02B 13/00; G02B 27/64

(52) U.S. Cl. CPC G03B 5/00; G02B 7/09; G02B 13/0065; G02B 27/646; G03B 2205/0023; G03B 2205/0069

(57) ABSTRACT

A camera module includes a housing, a reflection module including a reflective member, and supported on the housing, a lens module including a plurality of lenses arranged in an optical axis direction, and supported on the housing in a direction different from that of the reflection module, wherein the reflection module is configured to be rotatable with respect to the housing using an optical axis and a first axis perpendicular to the optical axis, as rotation axes, and the reflection module is supported on the housing in the optical axis direction.

### CROSS-REFERENCE TO RELATED APPLICATIONS

This application claims the benefit under 35 USC 119 (a) of Korean Patent Application Nos. 10-2023-0151212 filed on Nov. 3, 2023, and 10-2024-0036643 filed on Mar. 15, 2024, in the Korean Intellectual Property Office, the entire disclosures of which are incorporated herein by reference for all purposes.

### BACKGROUND

### 1. Field

The present disclosure relates to a camera module.

### 2. Description of the Background

A camera (hereinafter referred to as a camera module) may be adopted for use in a portable electronic device such as a smartphone, a tablet PC, and a laptop.

A camera module included in a portable electronic device may be manufactured to have a degree of performance comparable to that of conventional cameras, and have functions such as autofocusing and optical imaging stabilization.

Meanwhile, since a space in which a camera module may be mounted in a portable electronic device may be limited, the camera module may be provided with a reflective member to secure a sufficient total track length (TTL) within the limited space.

In this case, the optical imaging stabilization function of the camera module may be implemented by tilting a reflection module including the reflective member.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a reflection module including a reflective member, and supported on the housing, and a lens module including a plurality of lenses arranged in an optical axis direction, and supported on the housing in a direction different from that of the reflection module, wherein the reflection module is configured to be rotatable with respect to the housing using an optical axis and a first axis perpendicular to the optical axis, as rotation axes, and the reflection module is supported on the housing in the optical axis direction.

The camera module may further include a plurality of ball members disposed between the reflection module and the housing, wherein the plurality of ball members may include a rotation axis ball through which the optical axis passes, and a plurality of guide balls disposed to be spaced apart from the rotation axis ball, and configured to roll when the reflection module rotates.

The reflection module may further include a rotation holder supported on the housing, and configured to rotate using the optical axis as a rotation axis, and a reflective holder supported on the rotation holder, and configured to rotate using the first axis as a rotation axis, wherein a direction in which the reflective holder is supported on the rotation holder may be parallel to a direction in which the rotation holder is supported on the housing.

The reflection module may further include a first shake correction driving unit configured to generate driving force to rotate the reflective holder using the first axis as a rotation axis, wherein the first shake correction driving unit may include a first shake correction magnet disposed on a bottom surface of the reflective holder and a first shake correction coil disposed in the housing to face the first shake correction magnet.

The rotation holder may include an opening penetrating the rotation holder in a direction in which the first shake correction magnet and the first shake correction coil face each other, wherein a bottom surface of the reflective holder on which the first shake correction magnet is disposed may be disposed in the opening.

The reflection module may further include a second shake correction driving unit configured to generate driving force to rotate the rotation holder using the optical axis as a rotation axis, wherein the second shake correction driving unit may include a second shake correction magnet disposed on a side surface of the rotation holder and a second shake correction coil disposed in the housing to face the second shake correction magnet.

The housing may further include a pulling yoke disposed to face the second shake correction magnet in the optical axis direction, to form magnetic attraction with the second shake correction magnet in the optical axis direction.

The second shake correction magnet may include a portion protruding toward the second shake correction coil further than one surface of the rotation holder on which the second shake correction magnet is disposed, wherein the pulling yoke may face the protruding portion of the second shake correction magnet in the optical axis direction.

The second shake correction magnet may be magnetized in a second axis direction, perpendicular to both the optical axis and the first axis.

The camera module may further include a plurality of ball members disposed to be spaced apart in a first axis direction between the reflective holder and the rotation holder to form the first axis.

The camera module may further include a pair of magnetic materials disposed on the reflective holder and the rotation holder, respectively, to face each other in the optical axis direction, to form magnetic attraction in the optical axis direction.

The camera module may further include a lens barrel on which at least one lens through which light is incident is mounted, wherein the lens barrel may be coupled to the reflection module and rotated with the reflection module using the optical axis and the first axis as rotation axes.

In another general aspect, a camera module includes a housing, a reflection module including a reflective member, and supported on one surface of the housing, a first lens module including at least one lens through which light is incident, and disposed on the reflection module so that light passing through the at least one lens is incident on the reflective member, and a second lens module including a plurality of lenses through which the light reflected by the reflective member and emitted is incident, wherein the reflection module is configured to be rotatable with respect to the housing using an optical axis of the second lens module and a first axis perpendicular to the optical axis of the second lens module as rotation axes, and wherein the reflection module is supported on the housing in the optical axis direction of the second lens module.

The reflection module may include a rotation holder supported on the housing, and configured to be rotated using the optical axis of the second lens module as a rotation axis, and a reflective holder supported on the rotation holder, and configured to be rotated using the first axis as a rotation axis.

The camera module may further include a plurality of ball members disposed between the rotation holder and a surface of the housing facing in the optical axis direction of the second lens module, wherein the plurality of ball members may include a rotation axis ball through which the optical axis passes, and a plurality of guide balls disposed to be spaced apart from the rotation axis ball, and configured to roll when the reflection module rotates.

The camera module may further include a plurality of ball members disposed between the reflective holder and the rotation holder, wherein the reflective holder is supported on the rotation holder in the optical axis direction of the second lens module by the plurality of ball members.

The reflection module may include a first shake correction driving unit including a first shake correction magnet and a first shake correction coil disposed to face each other in a second axis direction perpendicular to both the optical axis of the second lens module and the first axis, configured to generate driving force to rotate the reflective member using the first axis as a rotation axis, and a second shake correction driving unit comprising a second shake correction magnet and a second shake correction coil disposed to face each other in a direction of the first axis, configured to generate driving force to rotate the reflective member using the optical axis of the second lens module as a rotation axis.

In another general aspect, a camera module includes a housing, a reflection module comprising a reflective member disposed on a reflective holder rotatably disposed on a rotation holder, and rotatably disposed in the housing supported on a surface of the housing, a lens module disposed in the housing and comprising a plurality of lenses disposed in an optical axis direction along which light reflected by the reflective member is incident, a first shake correction magnet disposed on a bottom surface of the reflective holder and a first shake correction coil disposed in the housing to face the first shake correction magnet configured to generate driving force to rotate the reflective holder about a first axis perpendicular to the optical axis, and a second shake correction magnet disposed on a side surface of the rotation holder and a second shake correction coil disposed in the housing to face the second shake correction magnet configured to generate a driving force to rotate the rotation holder about the optical axis.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a diagram illustrating a state in which the case of FIG. 1 has been removed.

FIG. 3 is an exploded perspective view of a camera module according to an embodiment of the present disclosure.

FIG. 4 is a diagram illustrating a dispositional relationship of a camera module according to an embodiment of the present disclosure.

FIG. 5 is a perspective view of a housing according to an embodiment of the present disclosure.

FIG. 6 is a diagram illustrating a state in which a substrate is coupled to a housing according to an embodiment of the present disclosure.

FIG. 7 is a perspective view of a reflection module according to an embodiment of the present disclosure.

FIG. 8 is an exploded perspective view of a reflection module according to an embodiment of the present disclosure.

FIG. 9 is an exploded perspective view of a reflective holder and a rotation holder according to an embodiment of the present disclosure.

FIG. 10 is a bottom perspective view of a reflection module according to an embodiment of the present disclosure.

FIGS. 11A and 11B are diagrams for illustrating driving of a reflective holder according to an embodiment of the present disclosure.

FIG. 12 is a diagram for illustrating a support structure of a reflective holder according to an embodiment of the present disclosure.

FIGS. 13A and 13B are diagrams for illustrating driving of a rotation holder according to an embodiment of the present disclosure.

FIG. 14 is a diagram for illustrating a support structure of a rotation holder according to an embodiment of the present disclosure.

FIG. 15 is an exploded perspective view of a second lens module according to an embodiment of the present disclosure.

FIG. 16 is a diagram for illustrating a structure in which the second lens module is supported on the housing according to an embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a camera module that can minimize image resolution degradation occurring during handshake correction.

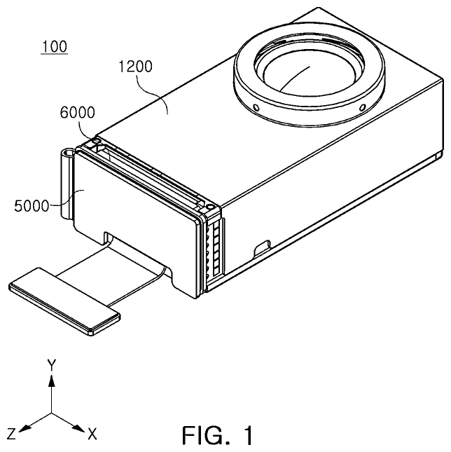

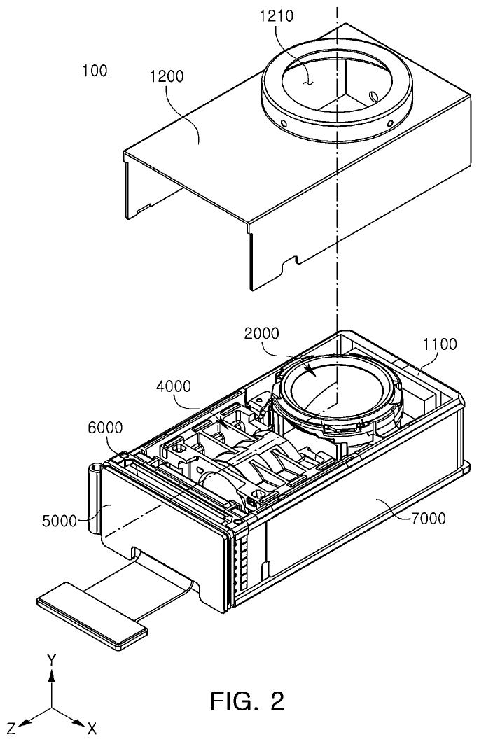

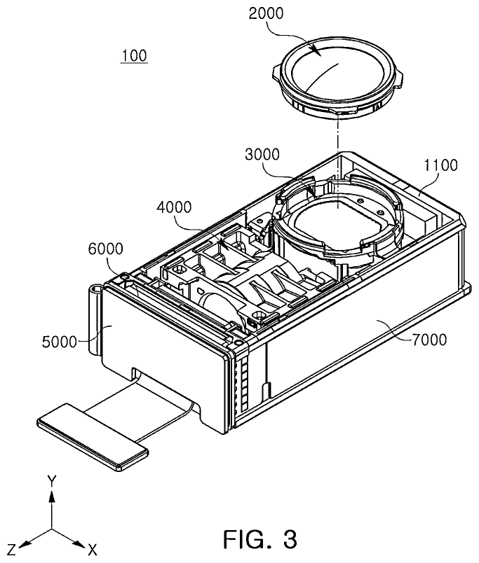

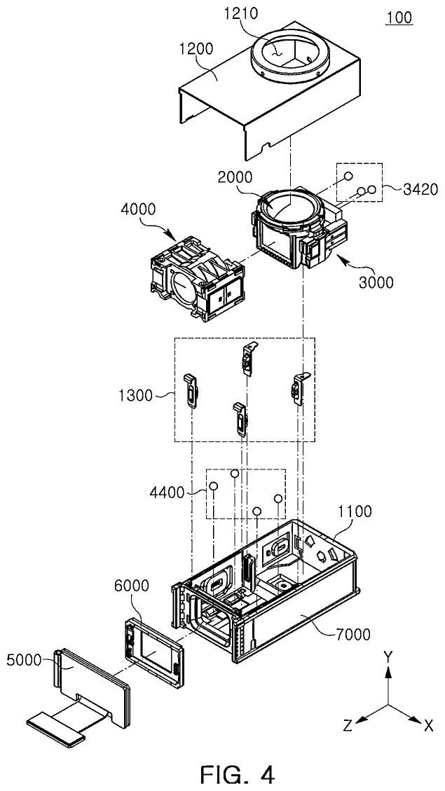

FIG. 1 is a perspective view of a camera module according to an embodiment of the present disclosure, FIG. 2 is a diagram illustrating a state in which the case of FIG. 1 has been removed, FIG. 3 is a diagram illustrating a dispositional relationship of a camera module according to an embodiment of the present disclosure, and FIG. 4 is an exploded perspective view of a camera module according to an embodiment of the present disclosure.

A camera module 100 according to an embodiment of the present disclosure may be mounted on a portable electronic device. As an example, the camera module 100 may be mounted on a smartphone. However, the type of portable electronic device on which the camera module 100 can be mounted is not limited to a smartphone.

Referring to FIG. 1, light reflected from an external subject may be incident in a direction parallel to a height direction (Y-axis direction) of the camera module 100, and the camera module 100 may have a length in one direction (Z-axis direction) perpendicular to the direction in which light is incident (Y-axis direction).

In an embodiment, the camera module 100 may be mounted on a smartphone so that the height direction (Y-axis direction) of the camera module 100 is parallel to a thickness direction of the smartphone. Accordingly, the camera module 100 may be relatively free of spatial constraints of the portable electronic device, at least in the longitudinal direction (Z-axis direction) of the camera module 100.

The camera module 100 according to an embodiment of the present disclosure may be configured to change a path of incident light once. For example, the camera module 100 may change the path of incident light, incident in a direction parallel to the height direction (Y-axis direction) of the camera module 100 in a direction parallel to the longitudinal direction (Z-axis direction) of the camera module 100. However, according to another embodiment, the path of incident light may be changed two or more times.

The camera module 100 according to an embodiment of the present disclosure may include a plurality of lens modules 2000 and 4000, a reflection module 3000, an image sensor module 5000, a housing 1100 in which those described above are disposed, and a case 1200 coupled to the housing 1100.

Referring to FIG. 2, the housing 1100 may have a length in one direction (Z-axis direction), and the plurality of lens modules 2000 and 4000 (hereinafter, referred to as a first lens module and a second lens module), the reflection module 3000, and the image sensor module 5000 may be disposed approximately in the longitudinal direction (Z-axis direction) of the housing 1100.

In an embodiment, the first lens module 2000 may be disposed in a direction parallel to the height direction (Y-axis direction) of the reflection module 3000 and the housing 1100, and the reflection module 3000, the second lens module 4000, and the image sensor module 5000 may be disposed in the longitudinal direction (Z-axis direction) of the housing 1100.

In addition, the first lens module 2000, the reflection module 3000, and the second lens module 4000 may be accommodated in an internal space of the housing 1100, and the image sensor module 5000 may be coupled to one side surface of the housing 1100 from the outside of the housing 1100.

Meanwhile, differently from that shown in FIG. 2, the first lens module 2000, the reflection module 3000, the second lens module 4000, and the image sensor module 5000 may each be provided in separately provided housings.

The case 1200 may be coupled to housing 1100 to cover the internal space of housing 1100. The case 1200 can protect the components accommodated in the internal space of the housing 1100 by covering the internal space of the housing 1100.

In addition, the case 1200 may be configured to shield electromagnetic waves. For example, the case 1200 may prevent the electromagnetic waves generated inside the camera module 100 from affecting the outside of the camera module 100 and at the same time prevent the electromagnetic waves generated outside the camera module 100 from affecting the inside of the camera module 100. To this end, the case 1200 may be manufactured to include a metal material.

The case 1200 may include an opening 1210 so that light reflected from an external subject may be incident within the camera module 100.

In an embodiment, the first lens module 2000 may be disposed in the opening 1210 (or the first lens module 2000 may be exposed to the outside of the camera module 100 through the opening 1210), and light reflected from an external subject may be incident on the camera module 100 through the first lens module 2000.

Referring to FIG. 3, light reflected from an external subject may sequentially pass through the first lens module 2000, the reflection module 3000, and the second lens module 4000 and may then be incident on the image sensor module 5000.

A path of light incident on the camera module 100 through the first lens module 2000 may be changed in the reflection module 3000. The reflection module 3000 may include a reflective member 3100 configured to change the path of incident light.

The incident light emitted from the reflection module 3000 may pass through the second lens module 4000 and then be incident on the image sensor module 5000.

The image sensor module 5000 receives light passing through the second lens module 4000, and may include an image sensor converting the incident light into an electrical signal and a sensor substrate on which the image sensor is mounted. The sensor substrate may be a printed circuit board.

Based on the path of incident light, an optical filter 6000 may be disposed in front of the image sensor module 5000. For example, the optical filter 6000 may be an infrared cut-off filter configured to cut-off light within an infrared wavelength range. Accordingly, among the incident light that has passed through the second lens module 4000, the remaining light excluding the light in the infrared wavelength range may be incident on the image sensor by the optical filter 6000.

Meanwhile, in another embodiment of the present disclosure, the camera module 100 may not include the first lens module 2000. In this case, a reflection module 3000 may be disposed in the opening 1210, and light reflected from an external subject may be incident on the camera module 100 through the reflection module 3000.

The camera module 100 according to an embodiment of the present disclosure may have an autofocusing (AF) function and an optical imaging stabilization (OIS) function. In addition, the camera module 100 may have an additional zoom function, but further description related thereto will be omitted.

The autofocusing function and the optical imaging stabilization function of the camera module 100 may be implemented by driving the second lens module 4000 and the reflection module 3000, respectively.

Referring to FIG. 4, in order to implement the above-described functions of the camera module 100, the second lens module 4000 and the reflection module 3000 may be movably supported on the housing 1100.

The autofocusing function of the camera module 100 may be implemented by moving the second lens module 4000 including a plurality of lenses arranged in an optical axis direction (Z-axis direction), in the optical axis direction (Z-axis direction).

In an embodiment, a plurality of ball members 4400 (hereinafter, referred to as a third ball group) supporting the movement of the second lens module 4000 in the optical axis direction (Z-axis direction) may be disposed between the second lens module 4000 and the housing 1100.

In another embodiment, the camera module 100 may have a zoom function. To this end, the camera module 100 may include a plurality of second lens modules 4000. As an example, the second lens module 4000 may include a plurality of lens holders 4100 on which at least one lens is mounted.

The zoom function of the camera module 100 may be implemented by moving at least one second lens module 4000 (or lens holder 4100) among the plurality of second lens modules 4000 (or lens holders 4100) in the optical axis direction (Z-axis direction).

The optical imaging stabilization function of the camera module 100 may be implemented by rotating the reflection module 3000 including the reflective member 3100 about two axes.

In an embodiment, the optical imaging stabilization function of the camera module 100 may be implemented by rotating the reflection module 3000 about an optical axis (Z-axis) and a first axis (X-axis) perpendicular to the optical axis, and to this end, a plurality of ball members 3420 (hereinafter, referred to as second ball group) to support the rotation of the reflection module 3000 may be disposed between the reflection module 3000 and the housing 1100.

Before describing the second lens module 4000 and the reflection module 3000 in detail, a structure of the housing 1100 and a main board 7000 coupled to the housing 1100 will first be described.

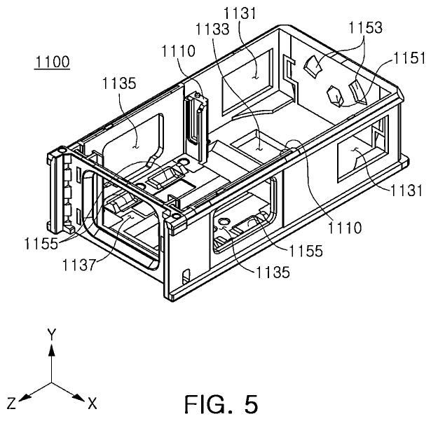

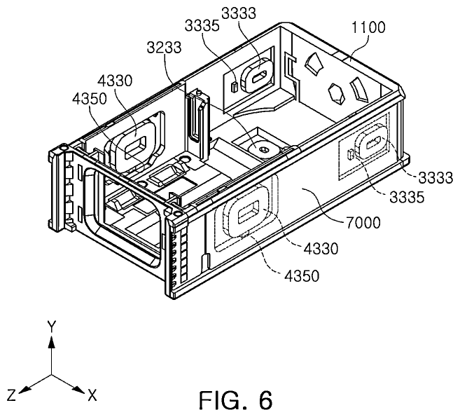

FIG. 5 is a perspective view of a housing according to an embodiment of the present disclosure, and FIG. 6 is a diagram illustrating a state in which a substrate is coupled to the housing according to an embodiment of the present disclosure.

Referring to FIG. 5, the housing 1100 may include a protruding wall 1110 formed to protrude toward an internal space from two side surfaces thereof, facing each other, respectively.

The protruding wall 1110 may partition the internal space of the housing 1100. For example, a reflection module 3000 may be disposed on one side of the protruding wall 1110, and a second lens module 4000 may be disposed on the other side thereof.

The protruding wall 1110 may be provided with a stopper 1300 preventing collision between the housing 1100 and the second lens module 4000 and regulating a movement range of the second lens module 4000. The stopper 1300 may also be provided on one surface of the housing 1100 facing the protruding wall 1110 in the optical axis direction (Z-axis direction). A detailed description related to the stopper 1300 will be described later.

In addition, the housing 1100 may include a plurality of grooves 1151, 1153, and 1155 accommodating portions of the second ball group 3420 and the third ball group 4400 disposed between the housing 1100 and the reflection module 3000 and the housing 1100 and the second lens module 4000.

In an embodiment, the housing 1100 may include one accommodation groove 1151 (hereinafter, referred to as a fourth accommodation groove) and a plurality of guide grooves 1153 (hereinafter, referred to as a second guide groove) on one side surface of the housing 1100 perpendicular to the longitudinal direction (Z-axis direction). A second ball group 3420 may be disposed in the fourth accommodation groove 1151 and the second guide groove 1153, and the reflection module 3000 may be supported on the housing 1100 in the optical axis direction (Z-axis direction) with the second ball group 3420 interposed therebetween.

In addition, the housing 1100 may include a plurality of guide grooves 1155 (hereinafter, referred to as third guide grooves) on a bottom surface facing the internal space. A third ball group 4400 may be disposed in the third guide groove 1155, and the second lens module 4000 may be supported on the housing 1100 with the third ball group 4400 interposed therebetween, in a second axis direction (Y-axis direction), perpendicular to both the optical axis and the first axis.

Meanwhile, the housing 1100 may include a plurality of through-holes 1131, 1133, 1135, and 1137 penetrating a side surface or bottom surface of the housing 1100.

A portion of a driving unit for driving the reflection module 3000 or the second lens module 4000, for example, a driving coil, a position sensor, and an image sensor module 5000 may be disposed in the plurality of through-holes 1131, 1133, 1135, and 1137.

In more detail, referring to FIG. 6, a main board 7000 on which a driving coil, or the like, is mounted, may be disposed in the housing 1100. The main board 7000 may be disposed on the outside of the housing 1100 to cover three side surfaces of the housing 1100 and a portion of the bottom surface of the housing 1100. In this case, a driving coil, or the like, mounted on the main board 7000 may be exposed to the internal space of the housing 1100 through the through-holes 1131, 1133, and 1135 formed in the housing 1100.

In an embodiment, the main board 7000 may be formed so that all portions disposed on different surfaces of the housing 1100 are integrally formed, and in this case, at least a portion of the main board 7000 may be formed of a flexible material. However, in another embodiment, the main board 7000 may be divided into a plurality of portions.

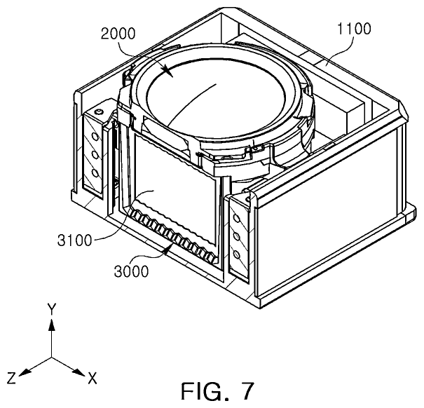

Next, with reference to FIGS. 7 to 14, a reflection module 3000 according to an embodiment of the present disclosure will be described.

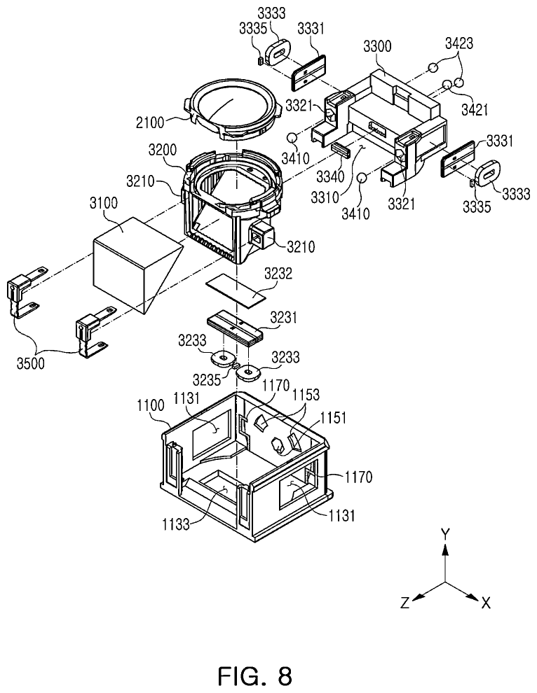

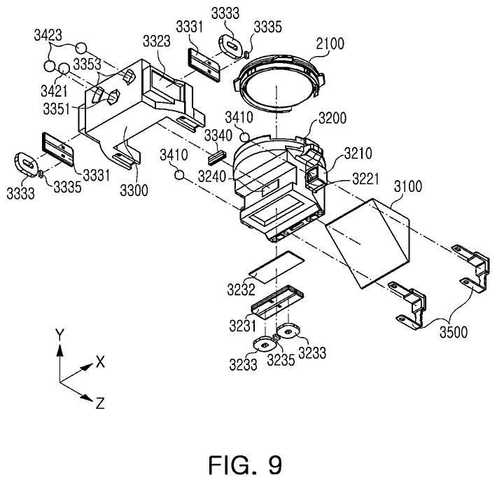

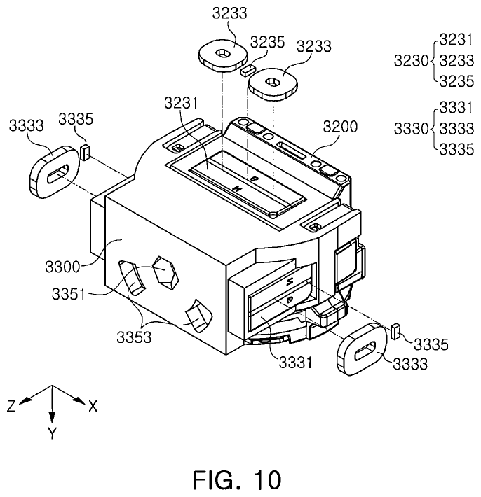

FIG. 7 is a perspective view of a reflection module according to an embodiment of the present disclosure, FIG. 8 is an exploded perspective view of a reflection module according to an embodiment of the present disclosure, FIG. 9 is an exploded perspective view of a reflective holder and a rotation holder according to an embodiment of the present disclosure, and FIG. 10 is a bottom perspective view of a reflection module according to an embodiment of the present disclosure.

Referring to FIG. 7, a reflection module 3000 may be disposed in the housing 1100 while being coupled to the first lens module 2000.

The first lens module 2000 may include a first lens barrel 2100 on which at least one lens (one or more lenses) is mounted, and the first lens barrel 2100 may be coupled to an upper side of the reflection module 3000. The at least one lens may be disposed in a first optical axis direction (Y-axis direction).

The reflection module 3000 may include a reflective member 3100, a reflective holder 3200 on which the reflective member 3100 is disposed, and a rotation holder 3300 on which the reflective holder 3200 is supported. The rotation holder 3300 may be supported on the housing 1100.

In an embodiment, the first lens barrel 2100 may be coupled to the reflective holder 3200. That is, at least one lens mounted on the first lens barrel 2100 and the reflective member 3100 may all be disposed on the reflective holder 3200, and the at least one lens and the first lens barrel 2100 may be disposed to overlap each other in the second axis direction (or first optical axis direction) (Y-axis direction).

The reflective member 3100 may refract or reflect incident light passing through the first lens module 2000 toward the second lens module 4000.

In an embodiment, the reflective member 3100 may be provided as a prism including an incident surface, a reflection surface, and an exit surface. However, in another embodiment, the reflective member 3100 may be provided as a mirror instead of a prism.

Referring to FIGS. 8 and 9, the reflective holder 3200 on which the first lens module 2000 and the reflective member 3100 are disposed may be rotatably supported on the rotation holder 3300.

In an embodiment, the reflective holder 3200 may be provided to be rotatable about the first axis (or first rotation axis) (X-axis) with respect to rotation holder 3300. To this end, a plurality of ball members 3410 (hereinafter, referred to as first ball group) supporting the rotation about the first rotation axis (X-axis) may be disposed between the reflective holder 3200 and the rotation holder 3300.

Since the first lens module 2000 and the reflective member 3100 are disposed on the reflective holder 3200, the first lens module 2000 and the reflective holder 3200 may be rotated with the reflective holder 3200 about the first rotation axis (X-axis) when the reflective holder 3200 rotates.

The rotation holder 3300 may be rotatably supported on the housing 1100.

In an embodiment, the rotation holder 3300 may be provided to be rotatable about the optical axis (or second rotation axis) (Z-axis) with respect to the housing 1100. To this end, a second ball group 3420 for supporting the rotation about the second rotation axis (Z-axis) of the rotation holder 3300 may be disposed between the rotation holder 3300 and the housing 1100.

Since the reflective holder 3200 is supported on the rotation holder 3300, it may be rotated about the second rotation axis (Z-axis) together with the rotation holder 3300 when the rotation holder 3300 rotates, and the first lens module 2000 and the reflective member 3100 disposed on the reflective holder 3200 may also be rotated about the second rotation axis (Z-axis) together with the reflective holder 3200.

The reflection module 3000 may include a driving unit (hereinafter referred to as a shake correction driving unit) generating driving force to rotate the reflection module 3000 about a first rotation axis (X-axis) and a second rotation axis (Z-axis).

The shake correction driving unit may include a magnet and a coil, and include a first shake correction driving unit 3230 forming driving force to rotate the reflective holder 3200 about the first axis (X-axis) and a second shake correction driving unit 3330 forming driving force to rotate the rotation holder 3300 about the second rotation axis (Z-axis). That is, in an embodiment of the present disclosure, the driving force rotating the reflection module 3000 about the first rotation axis (X-axis) and/or the second rotation axis (Z-axis) may be electromagnetic force generated between the magnet and the coil.

The first shake correction driving unit 3230 may include a first shake correction magnet 3231 and a first shake correction coil 3233.

Referring further to FIG. 10, the first shake correction magnet 3231 may be disposed on a bottom surface of the reflective holder 3200, and the first shake correction coil 3233 may be disposed on a bottom surface of the housing 1100 facing the bottom surface of the reflective holder 3200.

A back yoke 3232 may be disposed between the first shake correction magnet 3231 and the reflective holder 3200. The back yoke 3232 is a portion of the reflective holder 3200 and may be exposed through the bottom surface of the reflective holder 3200, and the first shake correction magnet 3231 may be disposed on the back yoke 3232. The back yoke 3232 may prevent leakage of a magnetic field by focusing the magnetic flux of the first shake correction magnet 3231.

The first shake correction coil 3233 may be disposed on the bottom of the housing 1100 while mounted on the main board 7000, and may be exposed to the internal space of the housing 1100 through a through-hole 1133 formed on the bottom surface of the housing 1100.

The rotation holder 3300 may include an opening 3310, open in the second axis direction (Y-axis direction), and a bottom surface of the reflective holder 3200 may be disposed in the opening 3310 while the reflective holder 3200 is supported on the rotation holder 3300.

Accordingly, the bottom surface of the reflective holder 3200 may directly face the bottom surface of the housing 1100, and accordingly, the first shake correction magnet 3231 disposed on the bottom surface of the reflective holder 3200 and the first shake correction coil 3233 disposed on the bottom surface of the housing 1100 may face each other in the second axis direction (Y-axis direction).

In an embodiment, the first shaking correction magnet 3231 may include one magnet, and the first shaking correction coil 3233 may include two coils. That is, one first shake correction magnet 3231 may face two first correction shake coil 3233 in the second axis direction (y-axis direction).

The first shake correction magnet 3231 may be configured to have different polarities sequentially magnetized in a rotation direction. The first shake correction magnet 3231 may be configured so that a surface of the first shake correction magnet 3231 facing the first shake correction coil 3233 sequentially has a N pole (or S pole), a neutral area, a S pole (N pole) in the rotation direction of the rotation holder 3200, for example, in the optical axis direction (z-axis direction).

When power is applied to the first shake correction coil 3233, the first shake correction coil 3233 may interact with the first shake correction magnet 3231 to generate driving force in a direction perpendicular to the direction in which they face each other, for example, in the optical axis direction (Z-axis direction), and the reflective holder 3200 may be rotated about the first rotation axis (X-axis) by resultant force of the driving force.

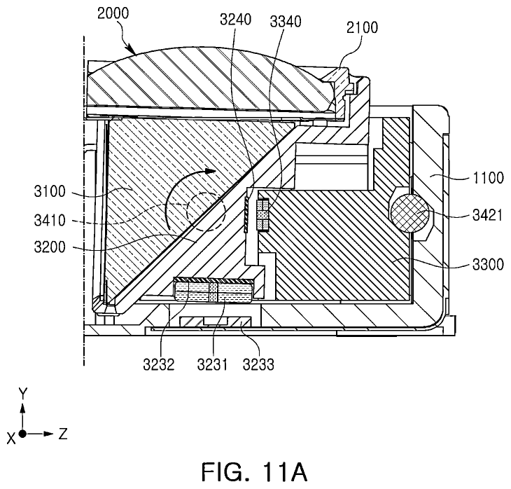

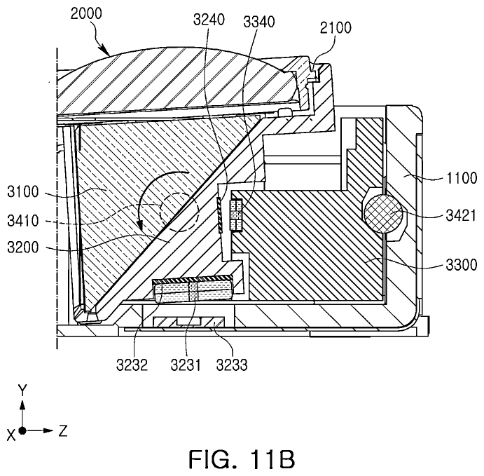

FIGS. 11A and 11B are diagrams for illustrating driving of a reflective holder according to an embodiment of the present disclosure.

Referring to FIGS. 11A and 11B, the reflective holder 3200 may be rotated about the first rotation axis (X-axis) with respect to the rotation holder 3300 by electromagnetic interaction between the first shake correction magnet 3231 and the first shake correction coil 3233.

A first ball group 3410 may be disposed between the reflective holder 3200 and the rotation holder 3300 to form a first rotation axis (X-axis) and support the rotation of the reflective holder 3200.

In an embodiment, the first ball group 3410 may include a plurality of ball members, for example, two ball members, disposed to be spaced apart in a first rotation axis direction (X-axis direction). The first rotation axis (X-axis) may pass through the first ball group 3410.

The reflective holder 3200 and the rotation holder 3300 may include a first accommodation groove 3221 and a second accommodation groove 3321 accommodating a plurality of ball members included in the first ball group 3410. For example, the first accommodation groove 3221 may be provided in the reflective holder 3200, and the second accommodation groove 3321 may be provided in the rotation holder 3300.

The first accommodation groove 3221 and the second accommodation groove 3321 may each be provided in the same number as the plurality of ball members included in the first ball group 3410, for example, two, and these may be disposed to be spaced apart in the first rotation axis direction (X-axis direction).

The reflective holder 3200 may include a protrusion 3210 formed to protrude in a first rotation axis direction (X-axis direction) from a portion in which the reflective member 3100 is mounted, and the first accommodation groove 3221 may be provided on the protrusion 3210.

The first accommodation groove 3221 and the second accommodation groove 3321 may face each other in the optical axis direction (Z-axis direction), and the first ball group 3410 may be disposed between the first accommodation groove 3221 and the second accommodation groove 3321.

Different portions of the plurality of ball members included in the first ball group 3410 may be accommodation in the first accommodation groove 3221 and the second accommodation groove 3321, respectively. That is, a portion of the plurality of ball members may be accommodated in the first accommodation groove 3221, and the other portions thereof may be accommodation in the second accommodation groove 3321.

The first accommodation groove 3221 and the second accommodation groove 3321 may include grooves having at least three inclined surfaces to support the ball members accommodated therein at three or more points. Accordingly, the plurality of ball members included in the first ball group 3410 may form a first rotation axis (X-axis) while rotating in place while accommodated in the first accommodation groove 3221 and the second accommodation groove 3321.

Meanwhile, the first accommodation groove 3221 and the second accommodation groove 3321 may optionally include a groove having two inclined surfaces.

In an embodiment, a portion of the first accommodation grooves 3221 and the second accommodation grooves 3321 may have three inclined surfaces, and the others thereof may have two inclined surfaces. According to this structure, at least one of the plurality of ball members included in the first ball group 3410 further has a degree of freedom in one direction, so defects due to tolerances can be overcome.

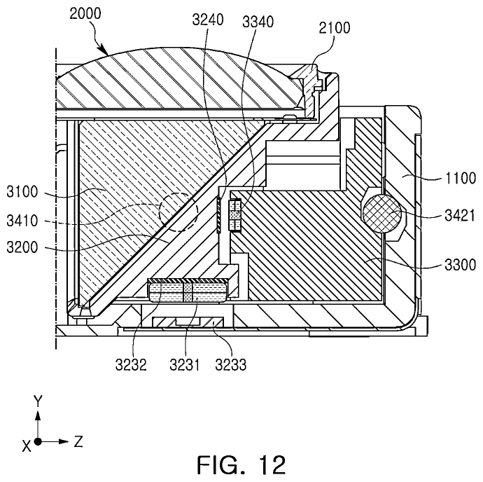

FIG. 12 is a diagram for illustrating a support structure of a reflective holder according to an embodiment of the present disclosure.

In order to prevent the first ball group 3410 from being separated, the reflective holder 3200 may be supported by the rotation holder 3300 with the first ball group 3410 interposed therebetween in an optical axis direction (Z-axis direction).

Referring to FIG. 12, a pair of magnetic materials 3240 and 3340 may be disposed in the reflective holder 3200 and the rotation holder 3300 to face each other in the optical axis direction (Z-axis direction).

In an embodiment, the pair of magnetic materials 3240 and 3340 may be a pulling yoke 3240 (or a first magnetic material) disposed in the reflective holder 3200 and a pulling magnet 3340 (or a second magnetic material) disposed in the rotation holder 3300.

The pulling yoke 3240 and the pulling magnet 3340 may generate magnetic attraction in a direction facing each other, that is, in the optical axis direction (Z-axis direction). Due to the magnetic attraction generated therebetween, the reflective holder 3200 may be supported in close contact with the rotation holder 3300 with the first ball group 3410 interposed therebetween.

In another embodiment, the positions of the pair of magnetic materials 3240 and 3340 described above may be changed. In addition, in another embodiment, another type of magnetic action (e.g., magnetic repulsion) may act between the pair of magnetic materials 3240 and 3340 described above.

The first shake correction driving unit 3230 may include a first position sensor 3235 for sensing a position of the first shake correction magnet 3231.

In an embodiment, the first position sensor 3235 may be mounted on the main board 7000, to be in parallel with the first shake correction coil 3233 and disposed in the housing 1100, and may face the first shake correction magnet 3231 through a through-hole 1133. For example, the first position sensor 3235 may face a neutral area of the first shake correction magnet 3231.

The first position sensor 3235 may be a magnetic sensor configured to sense a movement amount of the first shake correction magnet 3231 by sensing a change in a magnetic flux of the first shake correction magnet 3231. The first position sensor 3235 may be disposed to face the neutral area of the first shake correction magnet 3231, to effectively sense the change in the magnetic flux.

Meanwhile, although not illustrated in the drawing, a yoke may be further disposed on the other surface of the main board 7000, specifically, on a surface opposite to the surface in which the first shake correction coil 3233 and the first position sensor 3235 are disposed. The yoke can prevent leakage of the magnetic field by focusing the magnetic flux of the first shake correction magnet 3231.

The second shake correction driver 3330 may include a second shake correction magnet 3331 and a second shake correction coil 3333.

Referring further to FIG. 10, the second shake correction magnet 3331 may be disposed on both side surfaces of the rotation holder 3300, and the second shake correction coil 3333 may be disposed on both side surfaces of the housing 1100 facing both side surfaces of the rotation holder 3300, respectively.

Although not illustrated in the drawing, the second shake correction magnet 3331 may be disposed on a back yoke provided in the rotation holder 3300. The back yoke may prevent leakage of the magnetic field by focusing the magnetic flux of the second shake correction magnet 3331.

The second shake correction coil 3333 may be mounted on the main board 7000 and disposed on both side surfaces of the housing 1100, respectively, and may be exposed to the internal space of the housing 1100 through the through-hole 1131 respectively formed on both side surfaces of the housing 1100.

In an embodiment, the second shake correction magnet 3331 may include two magnets, and the second shake correction coil 3333 may include two coils. The second shake correction magnet 3331 and the second shake correction coil 3333 may be disposed on both side surfaces of the rotation holder 3300 and the housing 1100, respectively, and face each other in the first axis direction (X-axis direction).

The second shake correction magnet 3331 may be configured to have different polarities sequentially magnetized in a rotation direction. The second shake correction magnet 3331 may be configured so that a surface of the second shake correction magnet 3331 facing the second shake correction coil 3333 sequentially has an N-pole, a neutral area, and an S-pole (or an S-pole, a neutral area, and an N-pole) in the rotation direction of the rotation holder 3300, for example, in the second axis direction (Y-axis direction).

When power is applied to the second shake correction coil 3333, the second shake correction coil 3333 may interact with the second shake correction magnet 3331 to generate driving force in a direction perpendicular to the direction in which they face each other, for example, in the second axis direction (Y-axis direction), and the rotation holder 3200 may be rotated about the second rotation axis (Z-axis) by resultant force of the driving force.

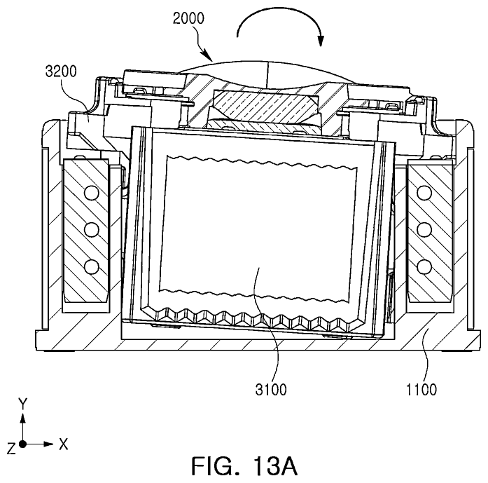

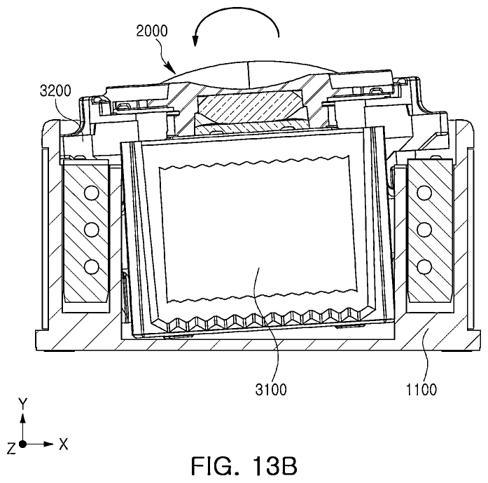

FIGS. 13A and 13B are diagrams for illustrating driving of a rotation holder according to an embodiment of the present disclosure.

Referring to FIGS. 13A and 13B, a rotation holder 3300 may be rotated about a second rotation axis (Z-axis) with respect to the housing 1100 by electromagnetic interaction of the second shake correction magnet 3331 and the second shake correction coil 3333. The second rotation axis (Z-axis) may be approximately parallel to an optical axis.

A second ball group 3420 may be disposed between the rotation holder 3300 and the housing 1100 to form a second rotation axis (Z-axis) and support the rotation of the rotation holder 3300.

In an embodiment, the second ball group 3420 may include one rotation axis ball 3421 and a plurality of guide balls 3423 disposed to be spaced apart from the rotation axis ball 3421.

The second rotation axis (Z-axis) may pass through the one rotation axis ball 3421. The plurality of guide balls 3423 may include one or more, for example, two ball members.

The rotation holder 3300 and the housing 1100 may include a third accommodation groove 3351 and a fourth accommodation groove 1151 accommodating the rotation axis ball 3421. For example, the third accommodation groove 3351 may be provided in the rotation holder 3300, and the fourth accommodation groove 1151 may be provided in the housing 1100.

The third accommodation groove 3351 and the fourth accommodation groove 1151 may face each other in the optical axis direction (Z-axis direction), and the rotation axis ball 3421 may be disposed between the third accommodation groove 3351 and the fourth accommodation groove 1151.

Different portions of the rotation axis ball 3421 may be accommodated in the third accommodation groove 3351 and the fourth accommodation groove 1151, respectively. That is, a portion of the rotation axis ball 3421 may be accommodated in the third accommodation groove 3351, and the other portions thereof may be accommodated in the fourth accommodation groove 1151.

At least one of the third accommodation groove 3351 and the fourth accommodation groove 1151 may be a groove having at least three inclined surfaces to support the rotation axis ball 3421 accommodated therein at three or more points. Accordingly, the rotation axis ball 3421 may form a second rotation axis (Z-axis) while rotating in place while accommodated in the third accommodation groove 3351 and the fourth accommodation groove 1151.

The rotation holder 3300 and the housing 1100 may include a first guide groove 3353 and a second guide groove 1153 accommodating a plurality of guide balls 3423. For example, the first guide groove 3353 may be provided in the rotation holder 3300, and the second guide groove 1153 may be provided in the housing 1100.

The first guide groove 3353 and the second guide groove 1153 may respectively be provided in the same number as the plurality of guide balls 3423, for example, two.

The first guide groove 3353 and the second guide groove 1153 may have a shape extending approximately in a circumferential direction of a circle centered on the rotation axis ball 3421. For example, the first guide groove 3353 and the second guide groove 1153 may have a straight or curved shape.

The first guide groove 3353 and the second guide groove 1153 may face each other in the optical axis direction (Z-axis direction), and a plurality of guide balls 3423 may be disposed between the first guide groove 3353 and the second guide groove 1153, respectively.

Different portions of the plurality of guide balls 3423 may be accommodated in the first guide groove 3353 and the second guide groove 1153, respectively. That is, a portion of the plurality of guide balls 3423 may be accommodated in the first guide groove 3353, and the other portions thereof may be accommodated in the second guide groove 1153.

The plurality of guide balls 3423 may contact the first guide groove 3353 and the second guide groove 1153 at one or two points, respectively. Accordingly, the plurality of guide balls 3423 may support the rotation of the rotation holder 3300 while rolling while accommodated in the first guide grooves 3353 and the second guide grooves 1153.

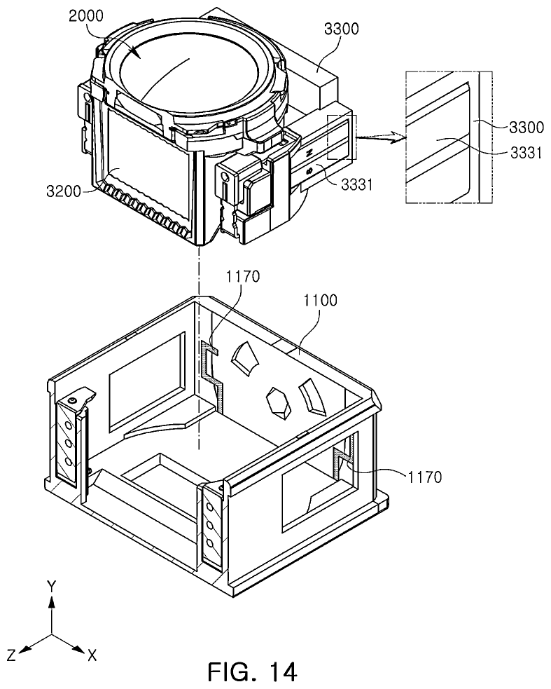

FIG. 14 is a diagram for illustrating a support structure of a rotation holder according to an embodiment of the present disclosure.

In order to prevent the second ball group 3420 from being separated, the rotation holder 3300 may be supported on the housing in the optical axis direction (Z-axis direction) with the second ball group 3420 interposed therebetween.

Referring to FIG. 14, a pair of magnetic materials 3331 and 1170 may be disposed in the rotation holder 3300 and the housing 1100 to face each other in the optical axis direction (Z-axis direction).

In an embodiment, the pair of magnetic materials 3331 and 1170 may be a second shake correction magnet 3331 (or third magnetic material) disposed in the rotation holder 3330 and a pulling yoke 1170 (or fourth magnetic material) disposed in the housing 1100.

The pulling yoke 1170 may be disposed on both sides of a second rotation axis (Z-axis), which is a rotation axis of the rotation holder 3300, and may be disposed symmetrically with respect to the second rotation axis (Z-axis).

In an embodiment, the pulling yoke 1170 may have an overall shape extending approximately in the second axis direction (Y-axis direction). The pulling yoke 1170 may include a portion extending in the first axis direction (X-axis direction) and a portion extending in the second axis direction (Y-axis direction). The portion extending in the first axis direction (X-axis direction) and the portion extending in the second axis direction (Y-axis direction) of the pulling yoke 1170 may be provided alternately, and thus, the pulling yoke 1170 may have a shape similar to ‘?.’

The second shake correction magnet 3331 may be disposed so that a portion of the second shake correction magnet 3331 protrudes externally of the rotation holder 3300 so as to face the pulling yoke 1170 disposed in the housing 1100.

In an embodiment, when the second shake correction magnet 3331 is disposed on the rotation holder 3300, the second shake correction magnet 3331 may protrude further in the first axis direction (X-axis direction) than one surface of the rotation holder 3300 on which the second shake correction magnet 3331 is disposed.

For example, the second shake correction magnet 3331 may be disposed in a seating groove 3323 provided in the rotation holder 3300, and the second shake correction magnet 3331 may have a thickness, greater than a depth (or thickness) of the seating groove 3323 in which the second shake correction magnet 3331 is disposed. Accordingly, a portion of the second shake correction magnet 3331 may protrude externally of the seating groove 3323.

The second shake correction magnet 3331 and the pulling yoke 1170 may generate magnetic attraction in a direction facing each other, that is, in the optical axis direction (Z-axis direction). For example, a portion extending in the second axis direction (Y-axis direction) of the pulling yoke 1170 may substantially generate magnetic attraction with the second shake correction magnet 3331. By the magnetic attraction generated therebetween, the rotation holder 3300 may be supported in close contact with the housing 1100 with the second ball group 3420 interposed therebetween.

However, in another embodiment, another type of magnetic action (e.g., magnetic repulsion) may act between the pair of magnetic materials 3240 and 3340 described above.

The second shake correction driving unit 3330 may include a second position sensor 3335 for sensing a position of the second shake correction magnet 3331.

In an embodiment, the second position sensor 3335 may be mounted on the main board 7000 to be in parallel with the second shake correction coil 3333 and disposed in the housing 1100, and may face the second shake correction magnet 3331 through a through-hole 1131. For example, the second position sensor 3335 may face a neutral area of the first shake correction magnet 3331.

The second position sensor 3335 may be a magnetic sensor configured to sense a movement amount of the second shake correction magnet 3331 by sensing a change in a magnetic flux of the second shake correction magnet 3331. The second position sensor 3335 may be disposed to face the neutral area of the second shake correction magnet 3331, to effectively sense the change in the magnetic flux.

Meanwhile, although not illustrated in the drawing, a yoke may be further disposed on the other surface of the main board 7000, specifically, on a surface opposite to the surface in which the second shake correction coil 3333 and the second position sensor 3335 are disposed. The yoke can prevent leakage of the magnetic field by focusing the magnetic flux of the second shake correction magnet 3331.

Meanwhile, the reflection module 3000 may be provided with a stopper 3500 preventing collisions between components when the reflection module 3000 is rotated and regulating a rotation range of the reflection module 3000.

In an embodiment, the stopper 3500 may be coupled to a rotation holder 3300 to surround the protrusion 3210 of the reflective holder 3200. The stopper 3500 may be coupled to the rotation holder 3300 at a distance from the reflective holder 3200 so as not to interfere with the rotation of the reflective holder 3200 with respect to the rotation holder 3300.

In order to effectively absorb shock and noise caused by collisions, the stopper 3500 may be provided with a buffer member. For example, the buffer member may be provided to surround an upper edge portion of the stopper 3500.

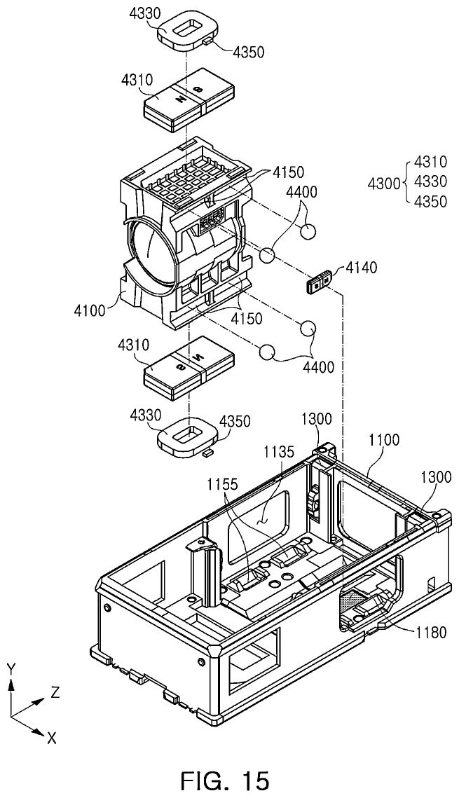

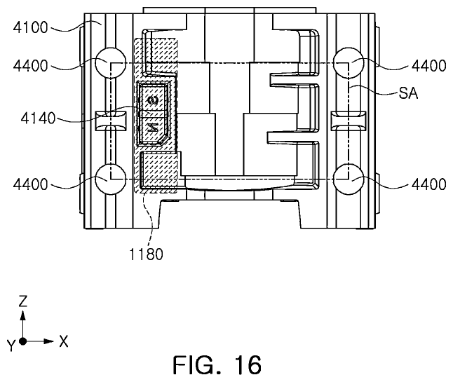

Next, referring to FIGS. 15 and 16, a second lens module 4000 according to an embodiment of the present disclosure will be described.

FIG. 15 is an exploded perspective view of a second lens module according to an embodiment of the present disclosure.

A second lens module 4000 may include a lens holder 4100 on which a plurality of lenses are mounted.

In an embodiment, a plurality of lenses may be mounted on the lens holder 4100 in an optical axis direction (or a second optical axis direction) (Z-axis direction) at predetermined intervals. Alternatively, in another embodiment, the plurality of lenses may be mounted on a lens holder via a lens barrel.

In addition, in the drawing, it is illustrated a plurality of lenses are mounted on a lens holder, but in another embodiment, a plurality of lenses may be mounted separately on a plurality of lens barrels (or lens holders), and in this case, the plurality of lens barrels (or lens holders) may be provided to be independently movable.

Referring to FIG. 15, the lens holder 4100 may be movably supported to be movable on the housing 1100.

In an embodiment, the lens holder 4100 may be provided to be movable in the optical axis direction (Z-axis direction) with respect to the housing 1100. To this end, a third ball group 4400 for guiding the movement of the lens holder 4100 in the optical axis direction (Z-axis direction) may be disposed between the lens holder 4100 and the housing 1100.

The second lens module 4000 may include a driving unit (hereinafter referred to as a focus adjustment driving unit) 4300 forming driving force for moving the second lens module 4000 in the optical axis direction (Z-axis direction).

The focus adjustment driving unit 4300 may include a magnet and a coil, and the driving force for moving the lens holder 4100 in the optical axis direction (Z-axis direction) may be an electromagnetic force generated between the magnet and the coil.

The focus adjustment driving unit 4300 may include a focus adjustment magnet 4310 and a focus adjustment coil 4330.

The focus adjustment magnet 4310 may be disposed on both side surfaces of the lens holder 4100, and the focus adjustment coil 4330 may be disposed on both side surfaces of the housing 1100 facing the side surface of the lens holder 4100.

Although not illustrated in the drawing, the focus adjustment magnet 4310 may be disposed on a back yoke provided in the lens holder 4100. The back yoke may prevent leakage of a magnetic field by focusing a magnetic flux of the focus adjustment magnet 4310.

The focus adjustment coil 4330 may be disposed on both side surfaces of the housing 1100 while the focus adjustment coil 4330 is mounted on a main board 7000, and may be exposed to the internal space of the housing 1100 through a through-hole 1135 formed on both side surfaces of the housing 1100.

The focus adjustment magnet 4310 and the focus adjustment coil 4330 may be disposed separately in the lens holder 4100 and the housing 1100, respectively, and face each other in a first axis direction (X-axis direction).

The focus adjustment magnet 4310 may be configured so that different polarities are sequentially magnetized in the same direction. The focus adjustment magnet 4310 may be configured so that a surface thereof facing the focus adjustment coil 4330 has an N-pole, a neutral area, and an S-pole (or an S-pole, a neutral region, and an N-pole), sequentially in a moving direction of the lens holder 4100, for example, an optical axis direction (Z-axis direction).

When power is applied to the focus adjustment coil 4330, the focus adjustment coil 4330 may interact with the focus adjustment magnet 4310, to generate driving force in a direction perpendicular to a direction in which they face each other, for example, an optical axis direction (Z-axis direction). The lens holder 4100 may be moved in the optical axis direction (Z-axis direction) by resultant force of the driving force.

The focus adjustment driving unit 4300 may include a third position sensor 4350 for sensing a position of the focus adjustment magnet 4310.

In an embodiment, the third position sensor 4350 may be mounted on the main board 7000 to be in parallel with the focus adjustment coil 4330 and disposed in the housing 1100, and may face the focus adjustment magnet 4310 through a through-hole 1135. For example, the third position sensor 4350 may face a neutral area of the focus adjustment magnet 4310.

The third position sensor 4350 may be a magnetic sensor configured to sense a movement amount of the focus adjustment magnet 4310 by sensing a change in a magnetic flux of the focus adjustment magnet 4310. The third position sensor 4350 may be disposed to face the neutral area of the focus adjustment magnet 4310, to effectively sense the change in the magnetic flux.

Although not illustrated in the drawing, a yoke may be further disposed on the other surface of the main board 7000, specifically, on a surface opposite to the surface in which the focus adjustment coil 4330 and the third position sensor 4350 are disposed. The yoke can prevent leakage of the magnetic field by focusing the magnetic flux of the focus adjustment magnet 4310.

A third ball group 4400 may be disposed between the lens holder 4100 and the housing 1100 to support the movement of the lens holder 4100.

In an embodiment, the third ball group 4400 may include three or more ball members, for example, four ball members. The four ball members are a pair of two ball members disposed to be spaced apart in the optical axis direction (Z-axis direction), and each of the four ball members may support one side or the other side of the lens holder 4100.

The lens holder 4100 and the housing 1100 may include a third guide groove 4150 and a fourth guide groove 1155 accommodating the third ball group 4400. For example, the third guide groove 4150 may be provided in the lens holder 4100, and the fourth guide groove 1155 may be provided in the housing.

The third guide groove 4150 and the fourth guide groove 1155 may be provided in the same number as the plurality of ball members included in the third ball group 4400, respectively, for example, four ball members.

The third guide groove 4150 and the fourth guide groove 1155 may have a shape extending approximately in the optical axis direction (Z-axis direction).

The third guide groove 4150 and the fourth guide groove 1155 may face each other in the second axis direction (Y-axis direction), and the plurality of ball members included in the third ball group 4400 may be disposed between the third guide groove 4150 and the fourth guide groove 1155, respectively.

Different portions of a plurality of ball members may be accommodated in the third guide groove 4150 and the fourth guide groove 1155, respectively. That is, a portion of the plurality of ball members included in the third ball group 4400 may be accommodated in the third guide groove 4150, and the other portions thereof may be accommodated in the fourth guide groove 1155.

The plurality of ball members included in the third ball group 4400 may contact the third guide groove 4150 and the fourth guide groove 1155 at one or two points, respectively.

FIG. 16 is a diagram for illustrating a structure in which a second lens module according to an embodiment of the present disclosure is supported on a housing.

In order to prevent the third ball group 4400 from being separated, the lens holder 4100 may be supported on the housing 1100 in the second axis direction (Y-axis direction) with the third ball group 4400 interposed therebetween.

Referring to FIGS. 15 and 16, a pair of magnetic materials 4140 and 1180 may be disposed in the lens holder 4100 and the housing 1100, respectively, to face each other in the second axis direction (Y-axis direction).

In an embodiment, the pair of magnetic materials 4140 and 1180 may be a pulling magnet 4140 (or fifth magnetic material) disposed in the lens holder 4100 and a pulling yoke 1180 (or sixth magnetic material) disposed in the housing 1100.

The pulling magnet 4140 and the pulling yoke 1180 may generate magnetic attraction in a direction facing each other, that is, in the second axis direction (Y-axis direction). By the magnetic attraction generated therebetween, the lens holder 4100 may be supported in close contact with the housing 1100 with the third ball group 4400 interposed therebetween.

Referring to FIG. 16, in order to stably support the movement of the lens holder 4100, the pulling magnet 4140 may be located inside the support area SA formed by a plurality of ball members included in the third ball group 4400, that is, four ball members.

For example, the lens holder 4100 may have four support points formed by four ball members, and the pulling magnet 4140 may be disposed inside a square-shaped support area (SA) with the four support points as the vertices. Therefore, an action point of the magnetic attraction generated between the pulling magnet 4140 and the pulling yoke 1180 may also be formed inside the support area (SA), and the lens holder 4100 may be more stably supported on the housing 1100.

Furthermore, according to an embodiment of the present disclosure, the pulling yoke 1180 disposed in the housing 1100 may be formed so that a surface thereof facing the pulling magnet 4140 has a larger area than the pulling magnet 4140 so as to cover the pulling magnet 4140 disposed in the lens holder 4100.

In an embodiment, the pulling yoke 1180 may be formed to have a length in an optical axis direction (Z-axis direction).

Accordingly, even if the lens holder 4100 moves in the optical axis direction (Z-axis direction) with respect to the housing 1100, since the pulling magnet 4140 can be maintained facing the pulling yoke 1180, the lens holder 4100 can be stably supported on the housing 1100.

Meanwhile, in another embodiment, the positions of the pair of magnetic materials 4140 and 1180 described above may be changed. In addition, in another embodiment, another type of magnetic action (e.g., magnetic repulsion) may act between the pair of magnetic materials 4140 and 1180 described above.

Meanwhile, the housing 1100 may be provided with a stopper 1300 to prevent collision between the housing 1100 and the second lens module 4000 due to the movement of the second lens module 4000 and to regulate a movement range of the second lens module 4000.

In an embodiment, the stopper 1300 may be provided on a protruding wall 1110 of the housing 1100 and on one surface facing the protruding wall 1110 in the optical axis direction (Z-axis direction).

The second lens module 4000 may be moved in the optical axis direction (Z-axis direction) with respect to the housing 1100 between the stopper 1300 disposed to be spaced apart in the optical axis direction (Z-axis direction).

In order to effectively absorb shock and noise caused by collision, the stopper 1300 may be provided with a buffer member. For example, the buffer member may be provided to protrude toward the second lens module 4000 (or lens holder 4100).

As set forth above, according to one or more embodiments of the present disclosure, image resolution degradation occurring during shake correction may be minimized.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a reflection module comprising a reflective member, and supported on the housing;
a lens module comprising a plurality of lenses arranged in an optical axis direction, and supported on the housing in a direction different from that of the reflection module,
wherein the reflection module is configured to be rotatable with respect to the housing using an optical axis and a first axis perpendicular to the optical axis, as rotation axes, and
the reflection module is supported on the housing in the optical axis direction.

2. The camera module of claim 1, further comprising:
a plurality of ball members disposed between the reflection module and the housing,
wherein the plurality of ball members comprise:
a rotation axis ball through which the optical axis passes; and
a plurality of guide balls disposed to be spaced apart from the rotation axis ball, and configured to roll when the reflection module rotates.

3. The camera module of claim 1, wherein the reflection module further comprises:
a rotation holder supported on the housing, and configured to rotate using the optical axis as a rotation axis; and
a reflective holder supported on the rotation holder, and configured to rotate using the first axis as a rotation axis, and
wherein a direction in which the reflective holder is supported on the rotation holder is parallel to a direction in which the rotation holder is supported on the housing.

4. The camera module of claim 3, wherein the reflection module further comprises:
a first shake correction driving unit configured to generate driving force to rotate the reflective holder using the first axis as a rotation axis, and
wherein the first shake correction driving unit comprises:
a first shake correction magnet disposed on a bottom surface of the reflective holder and a first shake correction coil disposed in the housing to face the first shake correction magnet.

5. The camera module of claim 4, wherein the rotation holder comprises:
an opening penetrating the rotation holder in a direction in which the first shake correction magnet and the first shake correction coil face each other, and
wherein a bottom surface of the reflective holder on which the first shake correction magnet is disposed is disposed in the opening.

6. The camera module of claim 3, wherein the reflection module further comprises a second shake correction driving unit configured to generate driving force to rotate the rotation holder using the optical axis as a rotation axis, and
wherein the second shake correction driving unit comprises:
a second shake correction magnet disposed on a side surface of the rotation holder and a second shake correction coil disposed in the housing to face the second shake correction magnet.

7. The camera module of claim 6, wherein the housing further comprises a pulling yoke disposed to face the second shake correction magnet in the optical axis direction, to form magnetic attraction with the second shake correction magnet in the optical axis direction.

8. The camera module of claim 7, wherein the second shake correction magnet comprises a portion protruding toward the second shake correction coil further than one surface of the rotation holder on which the second shake correction magnet is disposed, and
wherein the pulling yoke faces the protruding portion of the second shake correction magnet in the optical axis direction.

9. The camera module of claim 6, wherein the second shake correction magnet is magnetized in a second axis direction, perpendicular to both the optical axis and the first axis.

10. The camera module of claim 3, further comprising:
a plurality of ball members disposed to be spaced apart in a first axis direction between the reflective holder and the rotation holder to form the first axis.

11. The camera module of claim 3, further comprising:
a pair of magnetic materials disposed on the reflective holder and the rotation holder, respectively, to face each other in the optical axis direction, to form magnetic attraction in the optical axis direction.

12. The camera module of claim 1, further comprising:
a lens barrel on which at least one lens through which light is incident is mounted,
wherein the lens barrel is coupled to the reflection module and rotated with the reflection module using the optical axis and the first axis as rotation axes.

13. A camera module, comprising:
a housing;
a reflection module comprising a reflective member, and supported on one surface of the housing;
a first lens module comprising at least one lens through which light is incident, and disposed on the reflection module so that light passing through the at least one lens is incident on the reflective member; and
a second lens module comprising a plurality of lenses through which the light reflected by the reflective member is incident and emitted,
wherein the reflection module is configured to be rotatable with respect to the housing using an optical axis of the second lens module and a first axis perpendicular to the optical axis of the second lens module as rotation axes, and
wherein the reflection module is supported on the housing in the optical axis direction of the second lens module.

14. The camera module of claim 13, wherein the reflection module comprises:
a rotation holder supported on the housing, and configured to be rotated using the optical axis of the second lens module as a rotation axis; and
a reflective holder supported on the rotation holder, and configured to be rotated using the first axis as a rotation axis.

15. The camera module of claim 14, further comprising:
a plurality of ball members disposed between the rotation holder and a surface of the housing facing in the optical axis direction of the second lens module,
wherein the plurality of ball members comprise:
a rotation axis ball through which the optical axis passes; and
a plurality of guide balls disposed to be spaced apart from the rotation axis ball, and configured to roll when the reflection module rotates.

16. The camera module of claim 14, further comprising:
a plurality of ball members disposed between the reflective holder and the rotation holder,
wherein the reflective holder is supported on the rotation holder in the optical axis direction of the second lens module by the plurality of ball members.

17. The camera module of claim 13, wherein the reflection module comprises:
a first shake correction driving unit comprising a first shake correction magnet and a first shake correction coil disposed to face each other in a second axis direction perpendicular to both the optical axis of the second lens module and the first axis, configured to generate driving force to rotate the reflective member using the first axis as a rotation axis; and
a second shake correction driving unit comprising a second shake correction magnet and a second shake correction coil disposed to face each other in a direction of the first axis, configured to generate driving force to rotate the reflective member using the optical axis of the second lens module as a rotation axis.

18. A camera module, comprising:
a housing;
a reflection module comprising a reflective member disposed on a reflective holder rotatably disposed on a rotation holder, and rotatably disposed in the housing supported on a surface of the housing;
a lens module disposed in the housing and comprising a plurality of lenses disposed in an optical axis direction along which light reflected by the reflective member is incident;
a first shake correction magnet disposed on a bottom surface of the reflective holder and a first shake correction coil disposed in the housing to face the first shake correction magnet configured to generate driving force to rotate the reflective holder about a first axis perpendicular to the optical axis; and
a second shake correction magnet disposed on a side surface of the rotation holder and a second shake correction coil disposed in the housing to face the second shake correction magnet configured to generate a driving force to rotate the rotation holder about the optical axis.

19. The camera module of claim 18, further comprising:
a lens barrel on which at least one lens through which light is incident is mounted,
wherein the lens barrel is coupled to the reflection module and rotated with the reflection module using the optical axis and the first axis as rotation axes.
